(19) United States
(12) Patent Application Publication
(10) Pub. No.: US 2012/0124617 A1
(43) Pub. Date: May 17, 2012

(54) System and Method for Delivering Advertising to Members of a Pseudo-Social Network

(76) Inventor: Prabhakaran Krishnamoorthy, Namakkal (Dt) (IN)

(21) Appl. No.: 12/946,202

(22) Filed: Nov. 15, 2010

(51) Int. Cl. G06Q 30/00; H04N 7/10

(52) U.S. Cl. 725/32; 705/14.49

(57) ABSTRACT

A system and method for transmitting advertising to the members of a pseudo-social network are provided. The system and method comprise receiving a plurality of records corresponding to the members of the pseudo-social network and identifying a dominant member of the pseudo-social network. An advertisement for a product, service, business, or brand comprising review information authored by the dominant member is created. The advertisement is transmitted to the members of the pseudo-social network.

### FIELD OF THE INVENTION

The present invention relates to a method and system for delivering advertising to members of a pseudo-social network. More particularly, the invention relates to a technique for identifying a plurality of entities comprising a pseudo-social network and delivering advertising to the pseudo-social network including review information for a product, service, business, or brand from a member of the pseudo-social network.

### BACKGROUND

The nature and complexity of advertising has evolved considerably over the years. Whereas early advertisements appeared only in printed publications or public spaces, advertisements have now become ubiquitous in a variety of media. Advertising drives the production of free or low-cost content within numerous mediums, most notably television and the Internet.

The effectiveness of an advertisement derives primarily from its response rate. By appealing to people's sense of humor or other instincts, advertisers hope to capture an audience's attention and inculcate a positive impression of a product, service, business, or brand. However, even the most creative and meticulously selected advertisements may be ignored by a viewer, limiting their utility and effectiveness. Typically, advertisements comprise images, text, video, and/or audio containing generalized information relating to a product, service, or brand. Such advertisements do not generally contain information that is personally relevant to a viewer or specifically tailored to catch a particular viewer's eye. Even Internet advertising, which allows for more versatile advertising messages that can be tailored to a viewer based on his or her browsing habits, makes only limited use of viewer-specific information. These advertisements are more likely to be ignored by the viewer, even if they advertise a product, service, business, or brand that may be of interest to the viewer.

In contrast, a viewer is more likely to pay attention to an advertisement incorporating descriptions or impressions from a source the viewer trusts. An advertisement incorporating a review or testimonial from someone within one of the viewer's “pseudo-social” networks—a neighbor, a fellow member of a club, a co-worker, or other acquaintance—is much more likely to catch the viewer's eye than an advertisement with only generalized information. All people are members of pseudo-social networks arising from residence in a particular locality, membership in a particular organization, employment in a particular company, or other shared characteristic. The network may arise from relationships in real life or in the online world, such as a group of people who post messages to a particular blog or forum. The members of a pseudo-social network may or may not know each other personally, but are recognizable to each other due to their mutually shared association or characteristic. Consciously or unconsciously, the people within such a network develop a mutual bond of trust or interest in each other's lives.

Many pseudo-social networks may contain a dominant member who is recognized by a large number of other members. The dominant member may be, in the example of a pseudo-social network comprising people who live in a particular locality, a resident of that locality who frequently hosts parties or get-togethers. The dominant member may be recognizable to the other members as a personal acquaintance or a well-known person with notoriety within the network related to his status, wealth, position, or seniority. Members of the pseudo-social network are more likely to have a higher interest in the thoughts, impressions, and views of the dominant member.

The emergence of the Internet has allowed for easy collection and exchange of information about the members of a pseudo-social network and more versatility in transmitting information and content. Through agreements with organizations that gather or control data, Advertisers and content providers can access information that allows them to identify a pseudo-social network. Recent advances in video delivery technologies now allow video content providers to target specific viewers, either through traditional television transmission systems or programming transmitted over the Internet. Thus, it would be desirable have a technique that leverages the relationships that comprise a pseudo-social network and the trust they engender to deliver Internet advertising that is more likely to catch the viewer's eye.

As will be demonstrated, the present invention provides such a technique in an elegant manner.

### SUMMARY OF THE INVENTION

The present invention introduces methods and systems for identifying a member of a pseudo-social network and delivering advertising comprising the member's impressions of a product, service, or brand to the members of the pseudo-social network.

According to one embodiment, a plurality of records corresponding to a plurality of entities comprising a pseudo-social network of a user is received. The information comprising the records may be received from a third party based upon a pre-existing agreement governing access to or exchange of information. The plurality of entities is identified based on a criteria parameter. The criteria parameter may relate to residence in a particular locality, membership in a particular group, employment by a particular company, or other characteristic. A dominant entity is selected from among the plurality of entities. Review information from the dominant entity corresponding to a product, service, business, or brand is received. An advertisement for the product, service, business, or brand including the dominant entity's review information is created and transmitted to the entities comprising the pseudo-social network. The advertisement may be a video advertisement or an Internet advertisement. If the advertisement is a video advertisement, it may be transmitted using traditional television signal transmission technologies or via the Internet. If transmitted via traditional television signal transmission technologies, residence information corresponding to the entities comprising the pseudo-social network is received and used to target viewer-specific programming accordingly.

According to another embodiment, a criteria parameter is received comprising at least one of a user identifier corresponding to a user; a product, service, business, or brand parameter; a pseudo-social network parameter; and a dominant entity parameter. The pseudo-social network parameter may relate to residence in a particular locality, membership in a particular group, employment by a particular company, or other characteristic. The dominant entity parameter may relate to further characteristics or conditions associated with the pseudo-social network parameter. A record is received corresponding to a dominant entity that matches the criteria parameter. Review information associated with the dominant entity is received. The information comprising the record and the review information corresponding to the dominant entity may be received from a third party based upon a pre-existing agreement governing access to or exchange of information. An advertisement comprising said review information is created. The advertisement is transmitted to the user corresponding to the user identifier. If the advertisement is a video advertisement, it may be transmitted using traditional television signal transmission technologies or via the Internet. If transmitted via traditional television signal transmission technologies, residence information corresponding to the entities comprising the pseudo-social network is received and used to target viewer-specific programming accordingly.

### BRIEF DESCRIPTION OF THE DRAWINGS

FIG. 1 depicts a flowchart illustrating a procedure for delivering advertising to members of a pseudo-social network according to an embodiment of the invention.

FIG. 2 depicts a flowchart illustrating a procedure for identifying a plurality of entities comprising a pseudo-social network according to an embodiment of the invention.

FIG. 3 depicts a flowchart illustrating a procedure for identifying a dominant entity from among a plurality of entities comprising a pseudo-social network according to an embodiment of the invention.

FIG. 4 depicts a flowchart illustrating a procedure for receiving review information associated with a dominant entity from among a plurality of entities comprising a pseudo-social network according to an embodiment of the invention.

FIG. 5 depicts a flowchart illustrating a procedure for creating an advertisement comprising review information associated with a dominant entity from among a plurality of entities comprising a pseudo-social network according to an embodiment of the invention.

FIG. 6 depicts a flowchart illustrating a procedure for transmitting an advertisement to a user according to an embodiment of the invention.

FIG. 7 depicts a flowchart illustrating a procedure for delivering advertising to a member of a pseudo-social network according to an embodiment of the invention.

FIG. 8 depicts a flowchart illustrating a procedure for receiving review information associated with a dominant entity from among a plurality of entities comprising a pseudo-social network according to an embodiment of the invention.

FIG. 9A depicts a record including information about a user according to an embodiment of the invention.

FIG. 9B depicts a diagram illustrating two example pseudo-social networks of a user according to an embodiment of the invention.

FIG. 10A depicts records including information about several entities comprising a pseudo social network of a user according to an embodiment of the invention.

FIG. 10B depicts records including information about several entities comprising a pseudo social network of a user according to an embodiment of the invention.

FIG. 11A depicts records including review information associated with a dominant entity from among the entities comprising a pseudo-social network of a user according to an embodiment of the invention.

FIG. 11B depicts records including review information associated with a dominant entity from among the entities comprising a pseudo-social network of a user according to an embodiment of the invention.

FIG. 12A depicts an advertisement including review information according to an embodiment of the invention.

FIG. 12B depicts an advertisement including review information according to an embodiment of the invention.

FIG. 13 depicts a diagram illustrating an exemplary environment within which some embodiments of the invention operate.

FIG. 14 depicts a diagram illustrating an exemplary computing system for execution of the operations comprising various embodiments of the invention.

### DETAILED DESCRIPTION

Consumers often have strong opinions on the products, services, businesses, or brands that they deal with. There exist a number of services that specialize in collecting and presenting these opinions in the form of reviews and ratings. These services gather information through surveys conducted in person and over the telephone or through online applications. In addition to opinions, the information may include data that personally identifies a consumer, e.g., name, address, employment information, online username, etc. This information has heretofore seldom been used for targeted advertising purposes. Even advertising that contains consumer review information is often generalized such that the advertisement is designed to have mass appeal rather than capture the attention of a specific viewer.

The present invention provides a novel system and method for leveraging review information to target advertising to members of a pseudo-social network. Companies that provide communication services and transmit media content are uniquely positioned to deliver targeted advertising to their users. For instance, a cable television company has access to users' residence information and television viewing habits and can embed advertising that is tailored to a specific user within programming transmitted to that user. Similarly, by offering common online services and serving as a gateway for a user's Internet browsing sessions, Internet portals such as Yahoo!, may glean a variety of information about the user from the user's browsing habits and from data voluntarily submitted by the user. These portals can create, deliver, or host targeted advertising corresponding to the user's interests. By leveraging their own information and forming partnerships with organizations that collect information about consumer opinions of products, services, businesses, and brands, an online portal or communications services provider can build a comprehensive profile of a user, including the user's pseudo-social networks. The online portal or communications provider can present to a viewer an advertisement comprising the ratings and reviews of a person within one of the viewer's pseudo-social networks, increasing the chances that the advertisement catches the viewer's attention.

The techniques described herein may also be applied to print advertising. Many producers of advertising circulars distributed in newspapers or through the mail print custom advertisements that are targeted to a particular region, demographic, or segment of the population. The appeal of these advertisements to the group they are targeted to would be enhanced if they included the impressions of a well-known member of that group. In this embodiment, the pseudo-social network comprises the group receiving a particular run of print advertisements. An advertisement is created containing the impressions of a dominant member of the group and transmitted to a producer of print advertising, who incorporates the advertisement into an advertising circular for delivery to the members of the group.

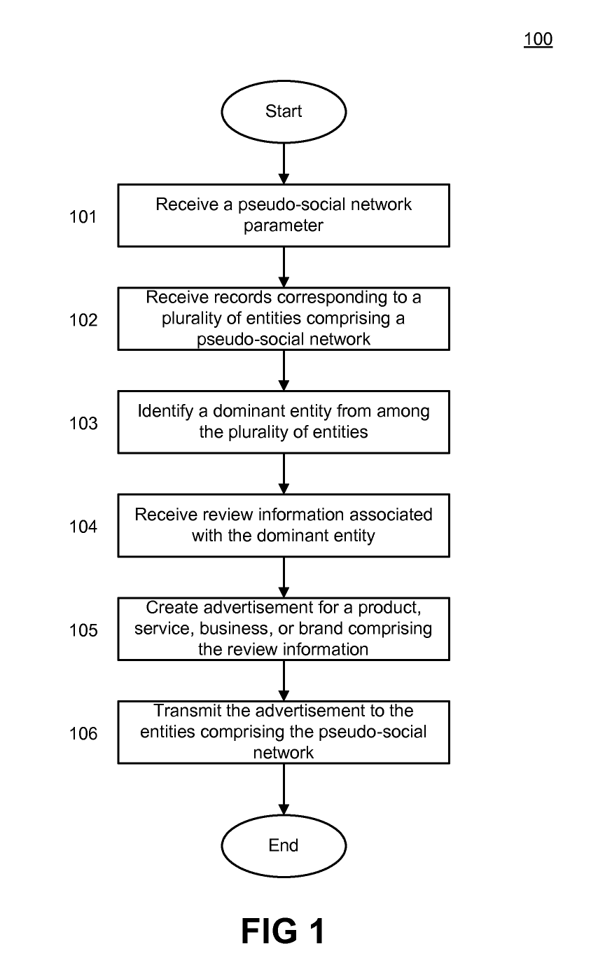

A flow diagram 100 illustrating an example embodiment of the present invention is depicted in FIG. 1. In this embodiment, an advertisement is created for a product, service, business, or brand that is determined based on the information retrieved relating to a pseudo-social network of a targeted user. At operation 101, a pseudo-social network parameter is received on the basis of which a pseudo-social network is to be identified. As noted above, the pseudo-social network parameter may be based on residence in a particular locality, membership in a particular organization, or any other characteristic by which people know each other. The pseudo-social network parameter may comprise multiple conditions and characteristics, e.g., entities that reside in a particular locality and are employed in a particular organization.

At operation 102, records corresponding to a plurality of entities that meet the pseudo-social network parameter are received. These entities comprise the pseudo-social network. The entities may be identified by querying an external or internal database for information corresponding to entities that match the pseudo-social network parameter or through other means. Access to the records may be governed by a pre-existing agreement with an external company or organization that collects and manages information about the entities.

At operation 103, a dominant entity from among the plurality of entities is identified. The dominant entity may be chosen by criteria that correspond to the pseudo-social network parameter used to identify the plurality of entities. For example, if the pseudo-social network is identified by membership in a particular organization, the dominant entity may be chosen as the longest-tenured employee of the organization. If the pseudo-social network is identified by membership in a particular locality, the dominant entity may be chosen as the resident who has lived in the locality the longest.

At operation 104, review information associated with the dominant entity is received. As with operation 102, the review information may be received by querying an internal or external database, and access to the review information may be governed by a pre-existing agreement with an outside company or organization. The review information may have been authored by the dominant entity previously as part of another procedure separate and independent from the current process. Alternatively, the review information may have been requested from and authored by the dominant entity specifically for the current process. The review information may correspond to the dominant entity's opinion of a product, service, business, or brand, and a parameter that identifies the dominant entity.

At operation 105, an advertisement for a product, service, business, or brand comprising the review information is created. The advertisement includes the dominant entity's review of the product, service, or brand, as well as an indicator identifying the dominant entity as the author of the review. The advertisement may be a digital image, a text string, or animation for display within a webpage. Alternatively, the advertisement may be a video. The review information may be embedded within the advertisement in the form of a text string, an image, a video, or an audio clip.

At operation 106, the advertisement is transmitted to the entities comprising the pseudo-social network. If the advertisement is an Internet advertisement for display within a webpage or other online interface, the advertisement is transmitted via the Internet using the entity's IP address. The entity is identified by an indicator file on the entity's computer (also known as a “cookie”) or by having submitted login information through an online portal during the course of a browsing session. If the advertisement is a television advertisement, the advertisement is transmitted by a cable television provider using the entity's residential information.

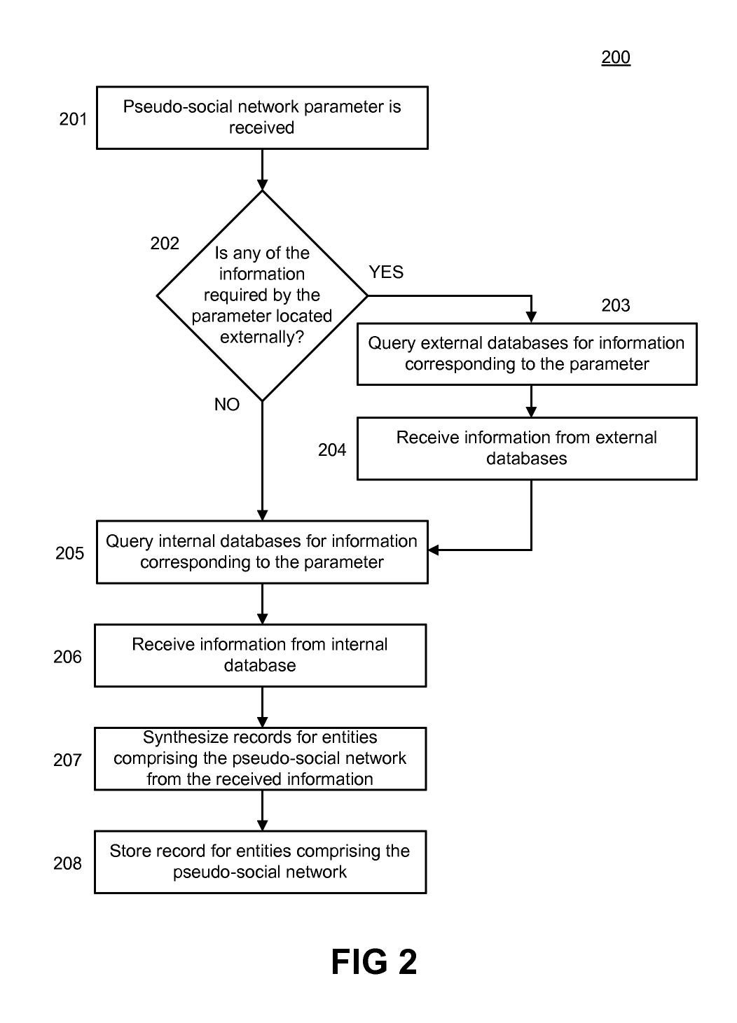

Operations 101 and 102 of FIG. 1 are illustrated in further detail according to an embodiment by the flow diagram 200 depicted in FIG. 2. At operation 201, a pseudo-social network parameter for identifying a pseudo-social network of the user is received. At operation 202, a determination is made if any of the information required by the pseudo-social network parameter is located externally. Access to this information may be governed by a pre-existing information exchange or license agreement with an outside organization. If there is required information located externally, external databases containing the information corresponding to the pseudo-social network parameter are queried at operation 203. At operation 204, information is received from the external databases in response to the query. At operation 205, internal databases containing the information corresponding to the criteria parameter are queried. At operation 206, information is received from the internal databases in response to the query. At operation 207, records corresponding to entities comprising the user's pseudo-social network are synthesized from the received information. Records corresponding to the entities comprising the user's pseudo-social network are stored at operation 208.

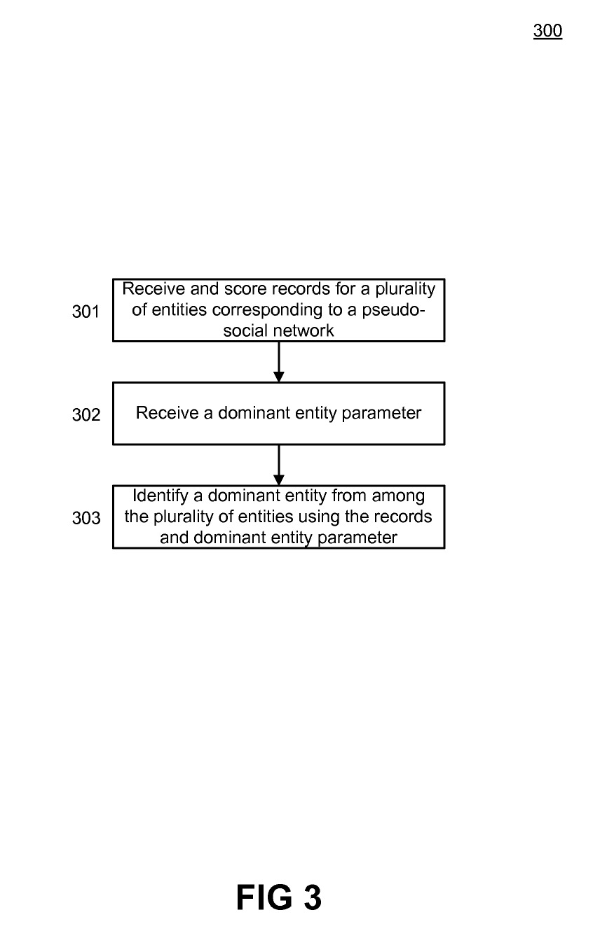

Operations 102 and 103 of FIG. 1 are illustrated in further detail according to an embodiment by the flow diagram 300 depicted in FIG. 3. At operation 301, records corresponding to a plurality of entities comprising a pseudo-social network of a user are received and stored. At operation 302, a dominant entity parameter is received. The dominant entity parameter may correspond to the pseudo-social network parameter, but is restricted by the data available in the records of the plurality of entities. For example, if the pseudo-social network criteria parameter relates to residence in a particular locality and the data in the received records specifies each entity's period of residence in that locality, then the dominant entity parameter may identify which entity has lived in that locality the longest. At step 303, a dominant entity from among the plurality of entities is identified using the records and the dominant entity parameter.

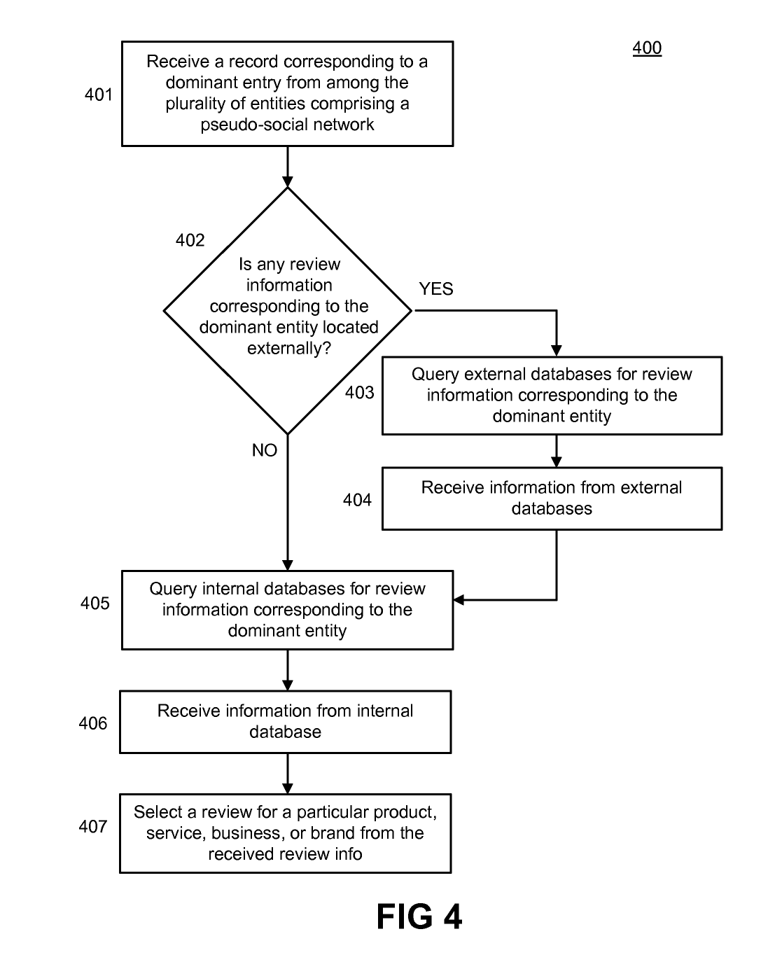

Operations 103 and 104 of FIG. 1 are illustrated in further detail according to an embodiment by the flow diagram 400 depicted in FIG. 4. At operation 401, a record corresponding to a dominant entity from among the plurality of entities comprising a pseudo-social network of a user is received. At operation 402, a determination is made if review information corresponding to the dominant entity is located externally. Access to this information may be governed by a pre-existing information exchange or license agreement with an outside organization. If review information is located externally, external databases containing review information corresponding to the dominant entity are queried at operation 403. At operation 404, information is received from the external databases in response to the query. At operation 405, internal databases containing review information corresponding to the dominant entity are queried. At operation 406, review information is received from the internal databases in response to the query. At operation 407, a review for a particular product, service, business, or brand for inclusion in the advertisement is selected from the received information. The review may be selected based on a variety of criteria, including length, date, substantive content, or at random, but comprises information relating only to the particular product, service, business, or brand.

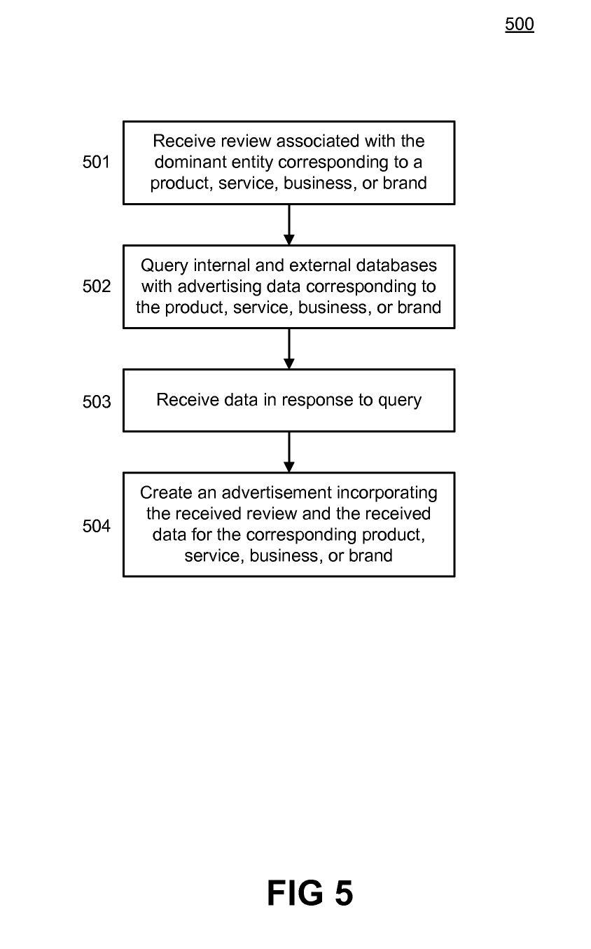

Operations 104 and 105 of FIG. 1 are illustrated in further detail according to an embodiment by the flow diagram 500 depicted in FIG. 5. At operation 501, a review associated with the dominant entity corresponding to a product, service, business, or brand is received. At operation 502, internal and external databases with data relating to the product, service, business, or brand are queried. At operation 503, data relating to the product, service, business, or brand is received in response to the query. At operation 504, an advertisement is created incorporating the received review and the received data for the corresponding product, service, business, or brand.

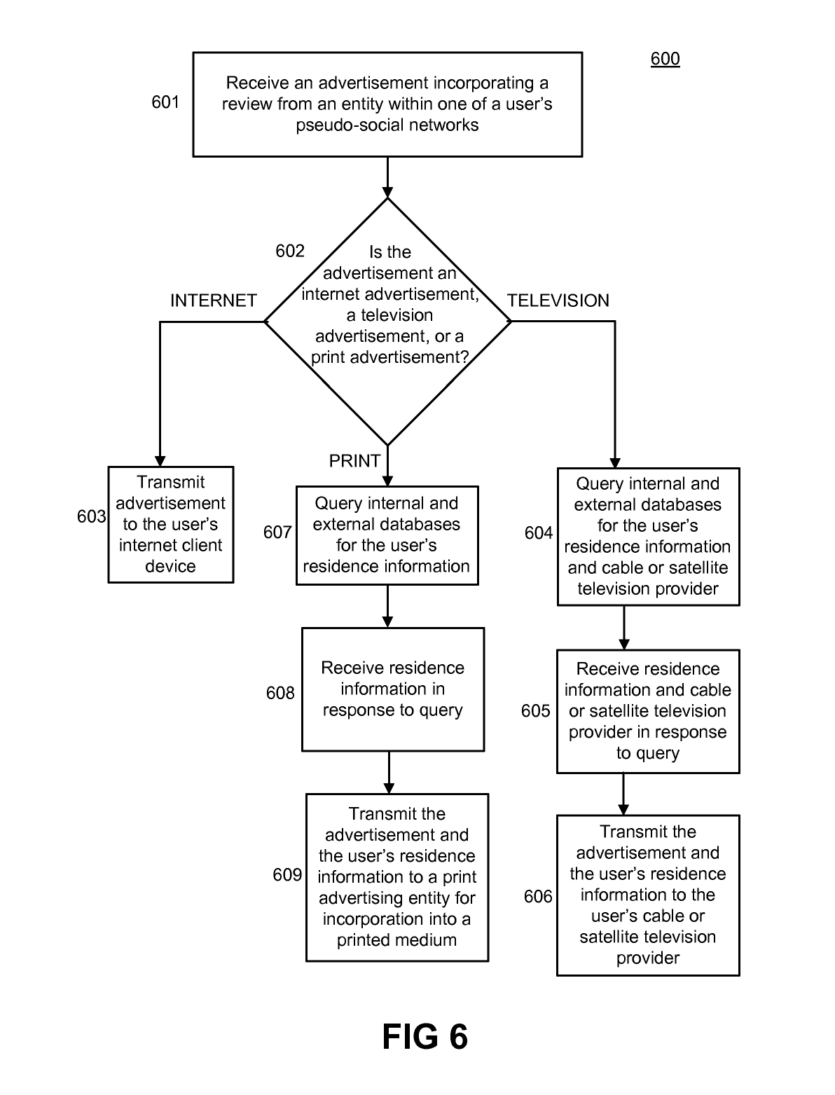

Operations 105 and 106 of FIG. 1 are illustrated in further detail according to an embodiment by the flow diagram 600 depicted in FIG. 6. At operation 601, an advertisement incorporating a review from an entity within one of a user's pseudo-social networks is received. At operation 602, a determination is made whether the advertisement is an Internet advertisement for display within a webpage or other online interface, a television advertisement for broadcast over a cable television connection, or a print advertisement for incorporation into a printed medium. If the advertisement is an Internet advertisement, the advertisement is transmitted to the user's Internet client device at operation 603. This can be done based on at least one of the user's IP address, a cookie, and the user's login credentials for an online portal or other service. If the advertisement is a television advertisement, internal or external databases are queried for the user's residence information and cable or satellite television provider at operation 604. At operation 605, the user's residence information and cable or satellite television provider are received. At operation 606, the advertisement and the user's residence information are transmitted to the user's cable or satellite television provider. If the advertisement is a print advertisement, internal or external databases are queried for the user's residence information at operation 607. At operation 608, the user's residence information is received. At operation 609, the advertisement is transmitted to a print advertising entity for incorporation into a printed medium. These operations are performed for each member of the pseudo-social network.

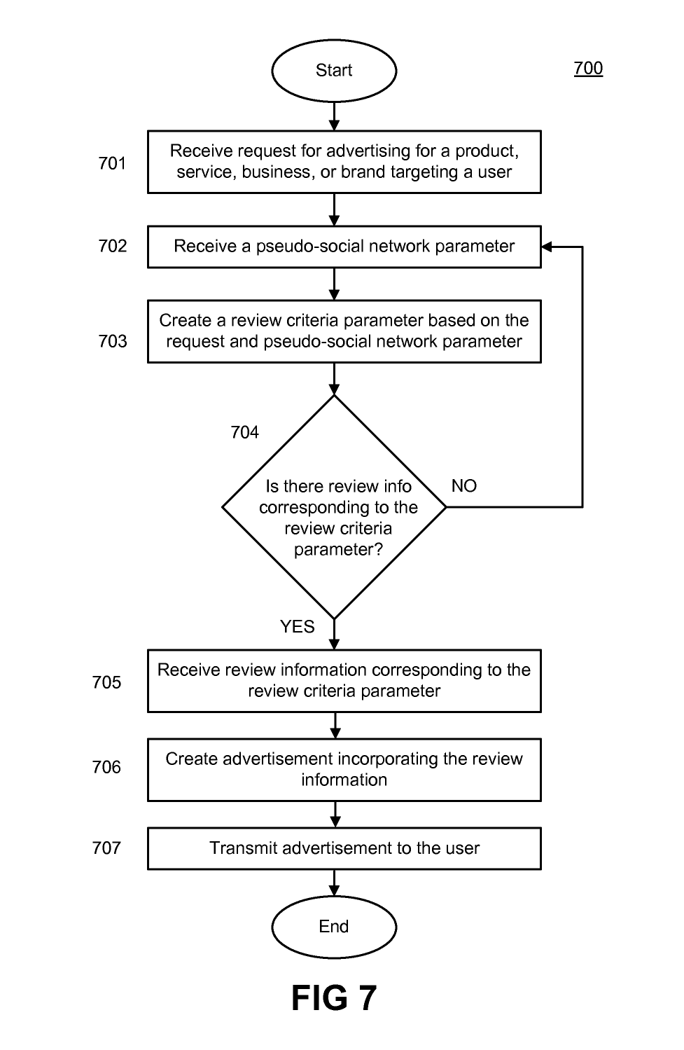

A flow diagram 700 illustrating an alternate embodiment of the invention is depicted in FIG. 7. In this embodiment, review information associated with an entity from among the entities comprising a pseudo-social network of a user is selected and retrieved based on a request for advertising for a particular product, service, business, or brand. In operation 701, a request for advertising for a particular product, service, business, or brand targeted at a particular user is received. In operation 702, a pseudo-social network parameter is received. At operation 703, a review parameter is created based on the request and the pseudo-social network criteria parameter. At step 704, a determination is made whether there exists review information corresponding to the dominant entity parameter. If such information does not exist, the procedure returns to step 702 to generate new criteria parameters. If such review information exists, the information is retrieved at operation 705. At operation 706, an advertisement is created incorporating the review information. At operation 705, the advertisement is transmitted to the user.

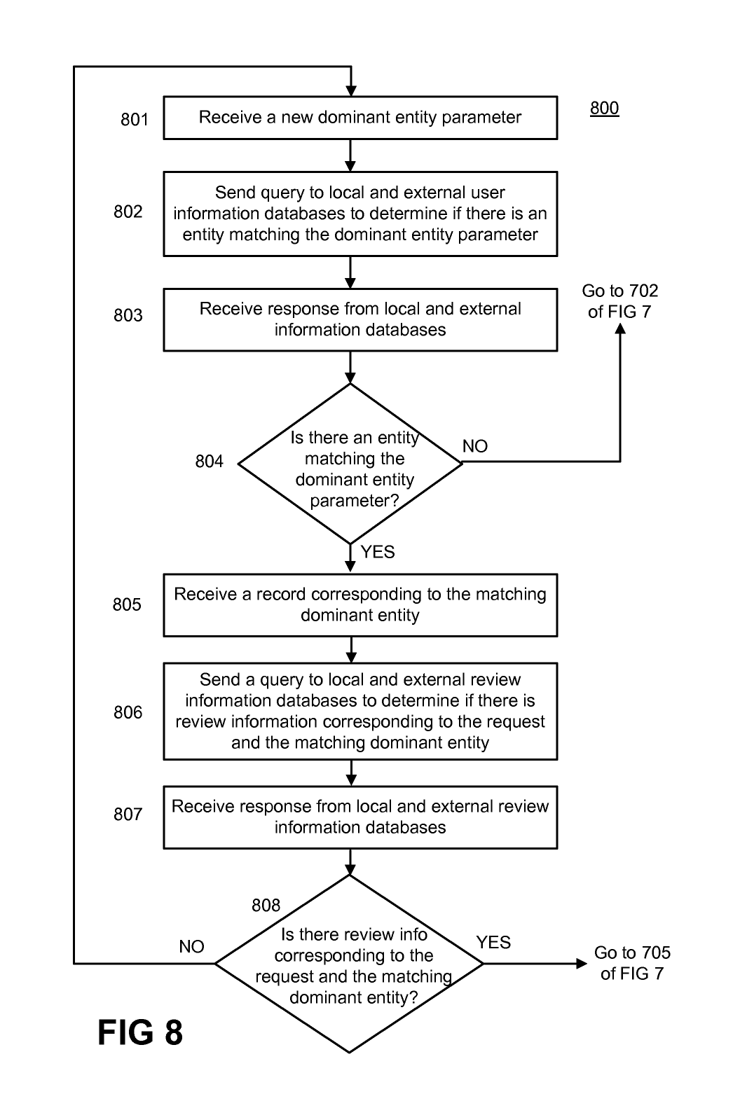

Operations 703 and 704 are illustrated in further detail according to an embodiment by the flow diagram 800 depicted in FIG. 8. At operation 801, a new dominant entity parameter is received. At operation 802, query is sent to local and external user information databases to determine if there is an entity matching the dominant entity parameter. A response to this query is received at operation 803. At operation 804 a determination is made: if there is not such an entity, the procedure returns to operation 702 of FIG. 7 to receive a new pseudo-social network parameter. If there is such an entity, the procedure proceeds to operation 805, at which a record corresponding to the dominant entity is received. At operation 806, a query is sent to local and external user information databases to determine if there is review information corresponding to the advertising request and the matching dominant entity. A response to this query is received at operation 807. At operation 808, a determination is made: if there is not such review information, the procedure returns to operation 801 to receive a new dominant entity parameter. If there is such review information, the procedure proceeds to operation 705 of FIG. 7. Access to information in external databases may be governed by an information exchange or license agreement with entities that control such information.

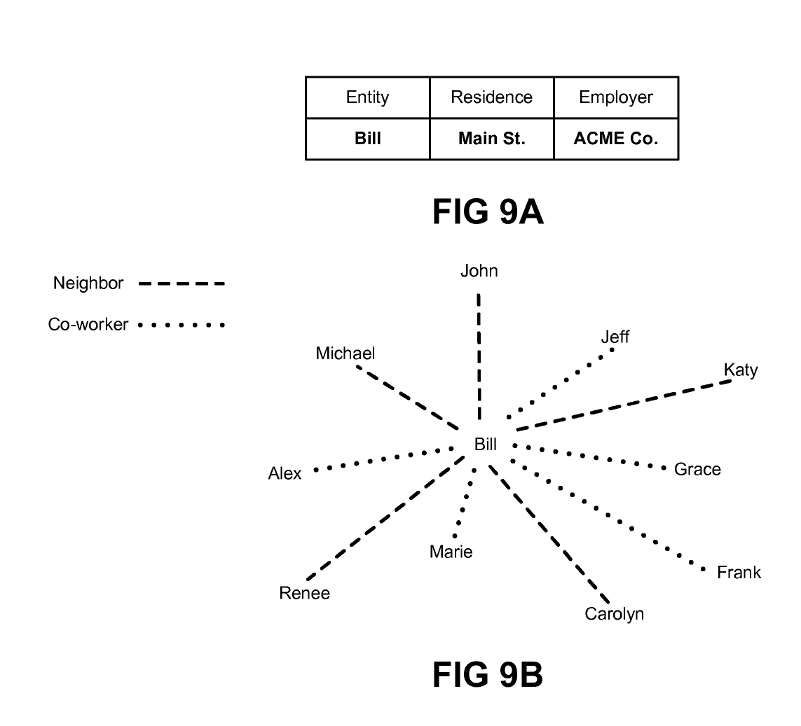

An example data set of a plurality of entities comprising two of a user's pseudo-social networks and accompanying review information according to an embodiment is illustrated in FIGS. 9A, 9B, 10A, 10B, 11A, and 11B. FIG. 9A depicts a record corresponding to known information about a user to whom advertising is to be delivered, Bill. This information may be located in a single internal or external database or across multiple internal or external databases. FIG. 9B depicts a set of relationships between Bill and entities John, Jeff, Katy, Grace, Frank, Carolyn, Marie, Renee, Alex, and Michael. As depicted in the diagram of FIG. 9B, Michael, John, Katy, Carolyn, and Renee are neighbors of Bill, while Alex, Jeff, Grace, Frank, and Marie are co-workers of Bill. Thus, according to this data, Bill has two pseudo-social networks: a neighbor pseudo-social network comprising Michael, John, Katy, Carolyn, and Renee and a co-worker pseudo-social network comprising Alex, Jeff, Grace, Frank, and Marie.

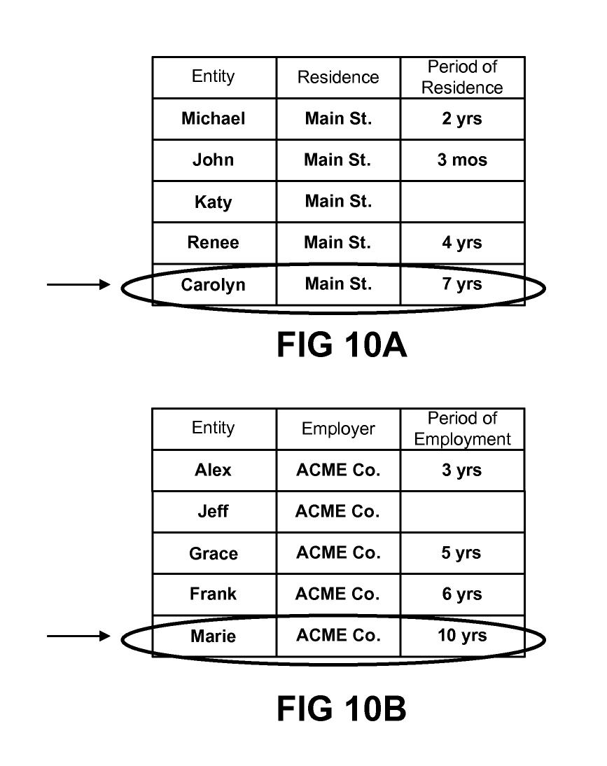

FIGS. 10A and 10B depict sets of records corresponding to the pseudo-social networks of Bill according to an embodiment. These records may have been assembled from data located in a single internal or external database or across multiple internal or external databases. According to one embodiment, each of the record sets may be assembled at operation 207 of FIG. 2 from information received in steps 204 and 206. FIG. 10A depicts a record set assembled from information received when the criteria parameter received at step 201 of FIG. 2 specifies residence on Main St. FIG. 10B depicts a record set assembled from information received when the criteria parameter received at step 201 of FIG. 2 specifies employment by ACME Co. Included in the record sets of FIGS. 10A and 10B is information specifying the period of residence and period of employment for the entities comprising Bill's neighbor pseudo-social network and co-worker pseudo-social network, respectively. This information may be used to identify a dominant entity at step 303 of FIG. 3 based on a dominant entity criteria parameter received at step 302. In FIG. 10A, if the dominant entity criteria parameter relates to longest period of residence, Carolyn is identified as the dominant entity. In FIG. 10B, if the dominant entity criteria parameter relates to longest period of employment, Marie is identified as the dominant entity.

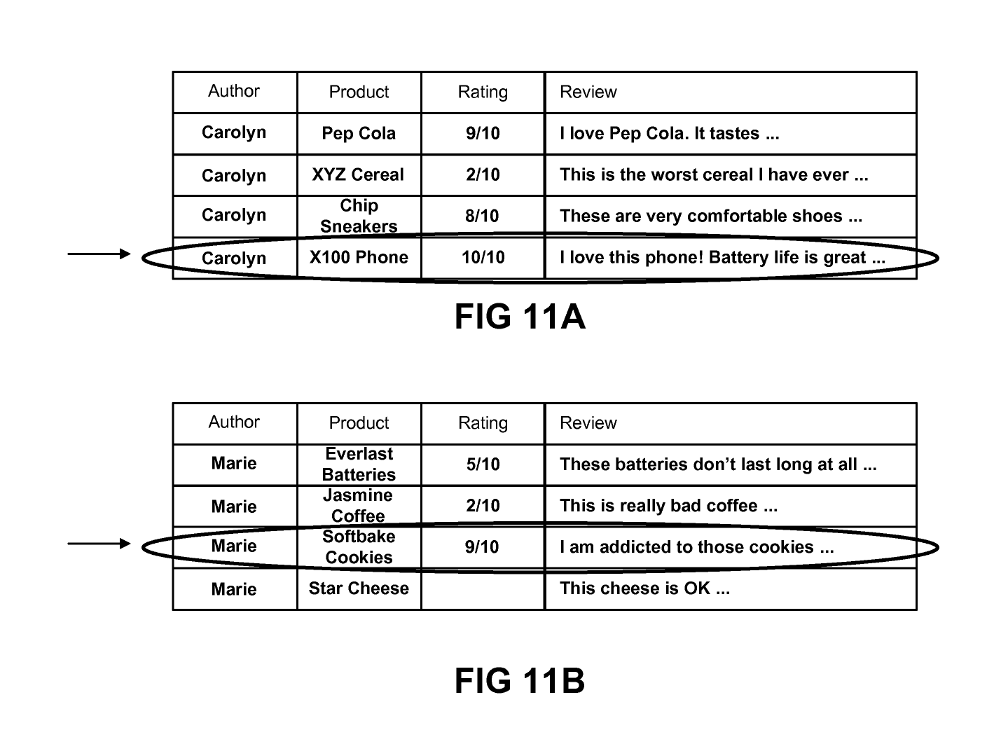

FIGS. 11A and 11B depict review information corresponding to the dominant entities in each of Bill's pseudo-social networks. The information may be located in a single internal or external database or across multiple internal or external databases. FIG. 11A depicts review information authored by Carolyn, the dominant entity identified in FIG. 10A. FIG. 11B depicts review information authored by Marie, the dominant entity identified in FIG. 10B. Each of FIGS. 11A and 11B depict review information relating to products provided by the dominant entity to various sources. According to an embodiment, a review may be selected from among the listed reviews at step 407 of FIG. 4. As noted above, the review may be selected based on any criteria. In this example, because the provided information includes a rating parameter, the review is selected based on the highest rating. Thus, in FIG. 11A, Carolyn's review of the X100 Phone s selected. In FIG. 11B, Marie's review of SoftBake Cookies is selected.

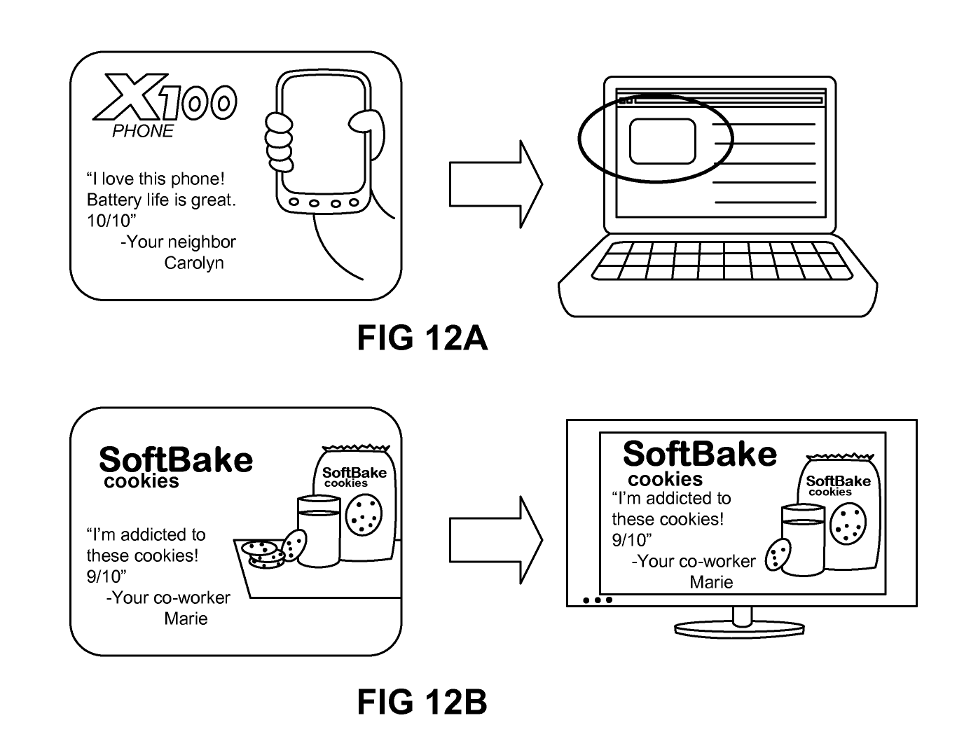

FIGS. 12A and 12B depict an example advertisement incorporating the selected review of the identified dominant entity. In FIG. 12A, an Internet advertisement for the X100 Phone including a portion of Carolyn's review, which is displayed in the form of a testimonial, is delivered to Bill's laptop computer during a browsing session. In FIG. 12B, a television advertisement for SoftBake Cookies including a portion of Marie's review, which is displayed in the form of a testimonial, is delivered to Bill's television via Bill's cable television connection.

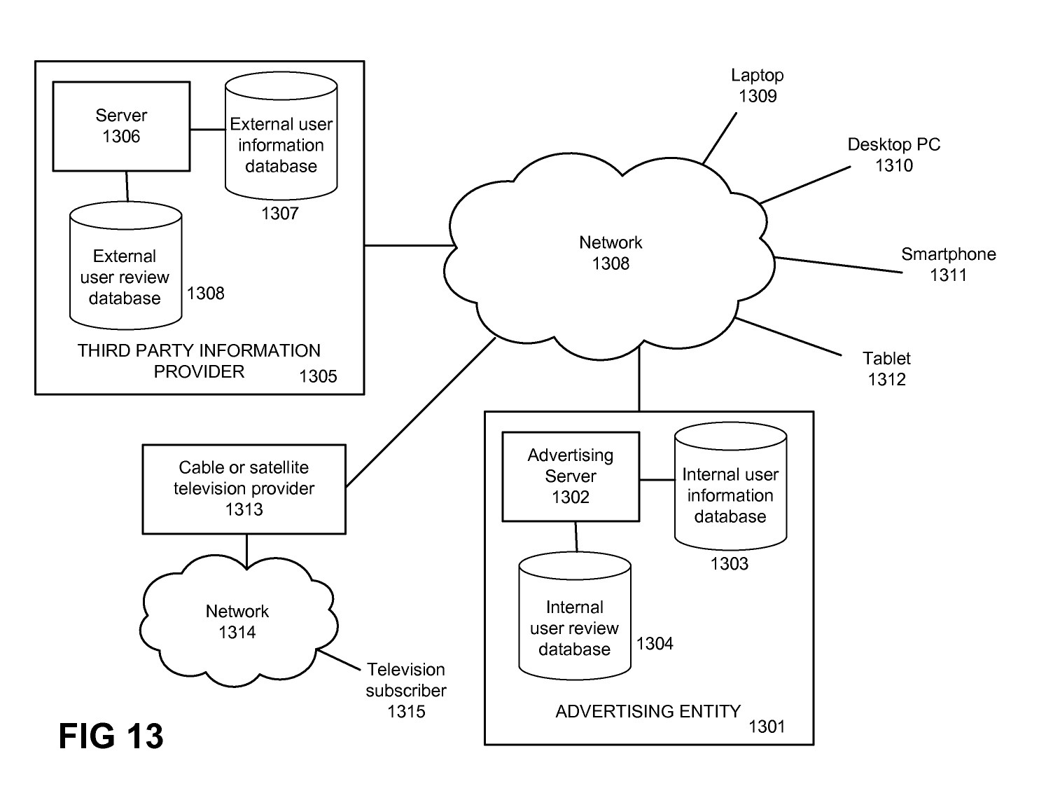

An exemplary environment within which some embodiments of the invention may operate illustrated in FIG. 13. The diagram of FIG. 13 depicts an advertising entity 1301. The advertising entity may be an online portal or content provider such as Yahoo!, or a stand alone entity that creates advertisements for online portals or content providers. The advertising entity includes an advertising server 1302 wherein the operations comprising the claimed embodiments are executed. Alternatively, the operations may be executed within other computer modules and components distinct from the advertising server 1302. The advertising entity may further include an internal user information database 1303 and a user review database 1304. Information used to assemble records of entities comprising pseudo-social networks and review information corresponding to the entities may be stored in user database 1303 and review information database 1304. Alternatively, all information located within the advertising entity 1301 may be collectively stored in a single database (not pictured).

Information may also be obtained from a third party information provider 1305. The third party information provider includes a server 1306 that receives queries and requests and transmits information to and from the advertising server 1302. The third party information provider also includes an external user information database 1307 and an external user review database 1308 that store user information and review information, respectively (the databases of the third party information provider and the advertising entity are identified as external and internal, respectively, from the perspective of the advertising entity). Alternatively, all information located within the third party information provider 1305 may be collectively stored in a single database (not pictured). There may be multiple third party information providers that receive and respond to requests for information from the advertising entity 1301.

All communication between and among the advertising entity 1302 and the third party information provider 1305 occurs via the network 1308. The network 1308 may comprise any combination of networks including, without limitation, the web (i.e. the Internet), a local area network, a wide area network, a wireless network, a cellular network, etc. Advertising, requests for advertising, and other information is transmitted to and from advertising entity 1305 via the network 1308. Advertising is received from the advertising entity 1305 via clients that may include, but are not limited to, a laptop PC 1309, a desktop PC 1310, a smartphone 1311, or a tablet device 1312.

Advertising may also be received by a cable or satellite television provider 1313. This advertising is transmitted or broadcast via a network 1314, which may comprise a network of fiber-optic transmission lines, a satellite network, a cellular network, a data network, or any combination thereof. Advertising transmitted or broadcast by the cable or satellite television provider 1313 may be received by a television subscriber 1315.

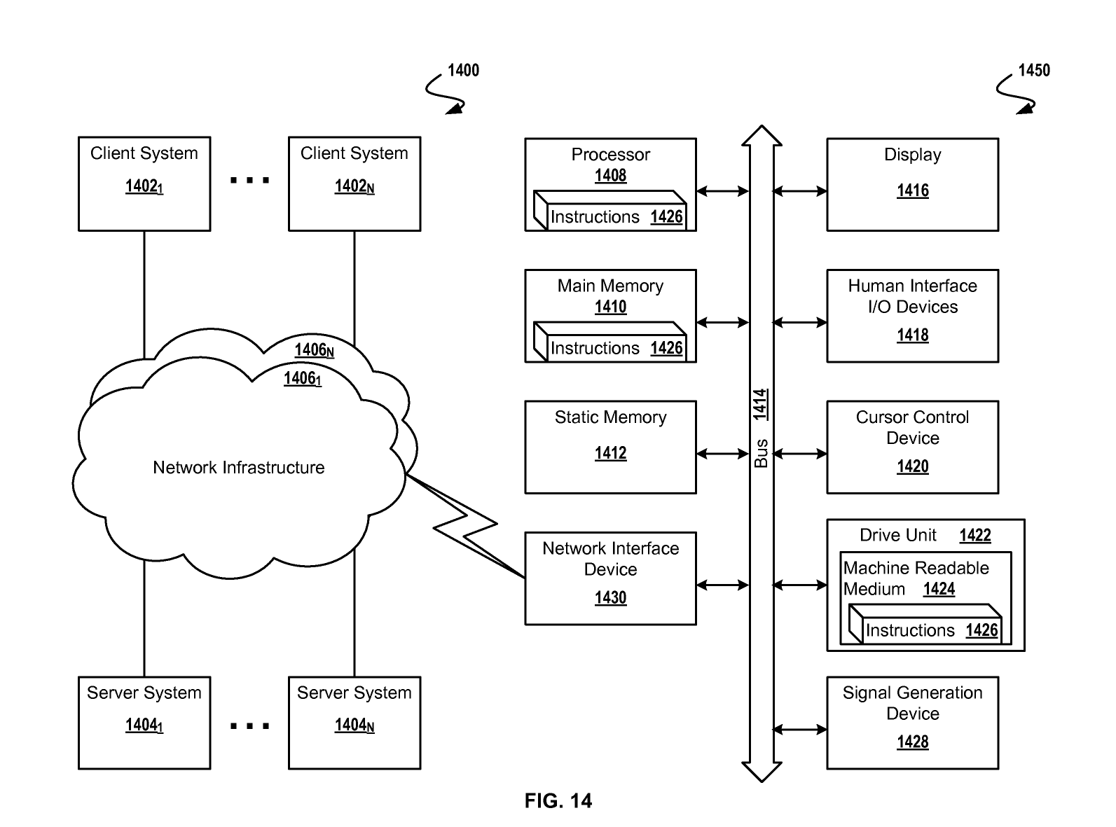

FIG. 14 is a diagrammatic representation of a network 1400, including nodes for client computer systems 1402₁ through 1402_{N}, nodes for server computer systems 1404₁ through 1404_{N}, nodes for network infrastructure 1406₁ through 1406_{N}, any of which nodes may comprise a machine 1450 within which a set of instructions for causing the machine to perform any one of the techniques discussed above may be executed. The embodiment shown is purely exemplary, and might be implemented in the context of one or more of the figures herein.

Any node of the network 1400 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1450 includes a processor 1408 (e.g. a processor core, a microprocessor, a computing device, etc), a main memory 1410 and a static memory 1412, which communicate with each other via a bus 1414. The machine 1450 may further include a display unit 1416 that may comprise a touch-screen, or a liquid crystal display (LCD), or a light emitting diode (LED) display, or a cathode ray tube (CRT). As shown, the computer system 1450 also includes a human input/output (I/O) device 1418 (e.g. a keyboard, an alphanumeric keypad, etc), a pointing device 1420 (e.g. a mouse, a touch screen, etc), a drive unit 1422 (e.g. a disk drive unit, a CD/DVD drive, a tangible computer readable removable media drive, an SSD storage device, etc), a signal generation device 1428 (e.g. a speaker, an audio output, etc), and a network interface device 1430 (e.g. an Ethernet interface, a wired network interface, a wireless network interface, a propagated signal interface, etc).

The drive unit 1422 includes a machine-readable medium 1424 on which is stored a set of instructions (i.e. software, firmware, middleware, etc) 1426 embodying any one, or all, of the methodologies described above. The set of instructions 1426 is also shown to reside, completely or at least partially, within the main memory 1410 and/or within the processor 1408. The set of instructions 1426 may further be transmitted or received via the network interface device 1430 over the network bus 1414.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

1. A computer implemented method for delivering advertising to members of a pseudo-social network, the method comprising:
storing, in a computer, a plurality of records corresponding to a plurality of entities, wherein the plurality of entities comprise the pseudo-social network and are identified by a criteria parameter;
selecting, in a computer, a dominant entity from among the plurality of entities;
receiving, at a computer, identifier information associated with the dominant entity;
receiving, at a computer, review information associated with the dominant entity; and
creating, in a computer, an advertisement comprising said identifier information and said review information.

2. The computer implemented method of claim 1, further comprising transmitting, using a computer, said advertisement to said plurality of entities.

3. The computer implemented method of claim 1, further comprising transmitting, using a computer, said advertisement to an advertising entity for incorporation into a printed medium.

4. The computer implemented method of claim 1, wherein said plurality of records is received from a third party based upon a pre-existing agreement.

5. The computer implemented method of claim 1, wherein said review information is received from a third party based upon a pre-existing agreement.

6. The computer-implemented method of claim 1, wherein said advertisement is a video advertisement.

7. The computer-implemented method of claim 2, wherein said transmitting is executed using a television signal transmission apparatus, said method further comprising receiving, at a computer, residence information corresponding to said plurality of entities.

8. The computer-implemented method of claim 2, wherein said transmitting is executed via the internet.

9. The computer-implemented method of claim 1, wherein the advertisement is an internet advertisement comprising at least one of a text string, an image, and an audio clip.

10. The computer-implemented method of claim 1, wherein the criteria parameter comprises residence in a particular locality.

11. The computer-implemented method of claim 1, wherein the criteria parameter comprises membership in a particular organization.

12. The computer-implemented method of claim 1, wherein the criteria parameter comprises employment in a particular firm.

13. A computer-implemented method for delivering advertising to members of a pseudo-social network, the method comprising:
receiving, at a computer, a criteria parameter comprising at least one of:
a user identifier corresponding to a user,
a product, service, business, or brand parameter,
a pseudo-social network parameter, and
a dominant entity parameter;
receiving, at a computer, a record corresponding to a dominant entity based on the criteria parameter;
receiving, at a computer, identifier information associated with the dominant entity;
receiving, at a computer, review information associated with the dominant entity; and
creating, in a computer, an advertisement comprising said identifier information and said review information.

14. The computer implemented method of claim 13 further comprising transmitting, using a computer, said advertisement to said user with said user identifier.

15. The computer implemented method of claim 13, further comprising transmitting, using a computer, said advertisement to an advertising entity for incorporation into a printed medium.

16. A computer readable medium comprising (or that stores) a set of instructions which, when executed by a computer, cause the computer to perform the steps of:
storing, in a computer, a plurality of records corresponding to a plurality of entities, wherein the plurality of entities comprise the pseudo-social network and are identified by a criteria parameter;
selecting, in a computer, a dominant entity from among the plurality of entities;
receiving, at a computer, identifier information associated with the dominant entity;
receiving, at a computer, review information associated with the dominant entity; and
creating, in a computer, an advertisement comprising said identifier information and said review information.

17. The computer readable medium of claim 16, wherein the steps further comprise transmitting, using a computer, said advertisement to said plurality of entities.

18. The computer readable medium of claim 16, wherein the steps further comprise transmitting, using a computer, said advertisement to an advertising entity for incorporation into a printed medium.

19. The computer readable medium of claim 16, wherein said plurality of records is received from a third party based upon a pre-existing agreement.

20. The computer readable medium of claim 16, wherein said review information is received from a third party based upon a pre-existing agreement.
